(19) United States
(12) Patent Application Publication
(10) Pub. No.: US 2025/0181804 A1
(43) Pub. Date: Jun. 5, 2025

(54) GLOBAL HEAT FLOW TOPOLOGY OPTIMIZATION TOOL FOR COLD ENERGY RECOVERY OF FLOATING STORAGE REGASIFICATION UNITS

(71) Applicant: DALIAN MARITIME UNIVERSITY, Dalian (CN)

(72) Inventors: Fenghui HAN, Dalian (CN); Zhe WANG, Dalian (CN); Ying WEI, Dalian (CN); Menglong CAO, Dalian (CN); Wenhua LI, Dalian (CN)

(21) Appl. No.: 18/944,376

(22) Filed: Nov. 12, 2024

(30) Foreign Application Priority Data
Dec. 1, 2023 (CN) 202311642101.4

(51) Int. Cl. G06F 30/28; G06F 17/11; G06F 111/10; G06F 119/08

(52) U.S. Cl. CPC G06F 30/28; G06F 17/11; G06F 2111/10; G06F 2119/08

(57) ABSTRACT

A global heat flow topology optimization tool for cold energy recovery of floating storage regasification units is provided, including: comparing heat flow topology based on energy conservation of each component of a system and inlet and outlet conditions, and establishing a preliminary heat flow topology tool; based on Kirchhoff's law and thermal current method, eliminating a redundant heat flow loop and establishing the final global heat flow topology tool; determining heat flow balance, thermal-hydraulic balance, working medium types, system working conditions and various constraint conditions of coupling links of each system; solving the heat flow topology tool and comprehensively analyzing the system performances; determining the objective functions, setting the decision-making interval, performing multi-objective optimization based on intelligent algorithm, and solving the optimal working condition parameters of the system; and introducing a system example, and analyzing the above methods to verify the accuracy of the calculation results of the example.

### CROSS-REFERENCE TO RELATED APPLICATIONS

This application claims priority to Chinese Patent Application No. 202311642101.4, filed on Dec. 1, 2023, the contents of which are hereby incorporated by reference.

### TECHNICAL FIELD

The disclosure relates to a global heat flow topology optimization tool for cold energy recovery of floating storage regasification units.

### BACKGROUND

Regasification is the final process of liquefied natural gas (LNG) supply chain. Compared with the traditional onshore LNG receiving station, floating storage regasification unit (FSRU) has great advantages in construction time, relocation and investment cost. Since the temperature of LNG is usually kept at −162° C., a large amount of cold energy is released to the surrounding seawater in the form of waste heat during the regasification process, and it is of great significance to integrate the LNG cold energy recovery technology into the FSRU regasification process. However, there are few analysis and modeling tools for this complex process, so the disclosure may realize the global heat flow topology of the cold energy recovery and regasification process of large-scale floating storage regasification units, make the performance optimization more controllable, and further effectively express the synergistic effect in this large-scale system.

### SUMMARY

The disclosure relates to a global heat flow topology optimization tool for cold energy recovery of a floating storage regasification unit, which includes a summary diagram of global heat flow topology modeling and optimization of a complex system, and specifically includes the following steps:
step 1, comparing heat flow topology based on energy conservation of each component of a system and inlet and outlet conditions, and establishing a preliminary heat flow topology tool;
step 2, combining with the preliminary heat flow topology tool, based on Kirchhoff's law and according to the thermal current method, eliminating the redundant heat flow loop and establishing the final global heat flow topology tool;
step 3, determining heat flow balance, thermal-hydraulic balance, working medium types, system working conditions and various constraint conditions of coupling links of each system;
step 4, based on the final global heat flow topology tool and heat flow balance, thermal-hydraulic balance, working medium types, system working conditions and various constraint conditions of coupling links of each system, solving the heat flow topology tool and comprehensively analyzing the system performance (energy analysis, exergy analysis and entransy transfer heat analysis, etc.);
step 5, on the basis of the step 4, determining objective functions (such as thermodynamic functions such as efficiency, exergy and dissipation), setting decision-making intervals, performing multi-objective optimization based on intelligent algorithm, and solving the optimal working condition parameters of the system; and
step 6, introducing an example of FSRU system, and analyzing the above methods to verify the accuracy of the calculation results of the example.

In the preferred embodiment, when the final global heat flow topology tool is established in step 2, through the principle of analog circuit, the closed loop including thermodynamic potential may be eliminated without changing the basic properties of the system, thus simplifying the model and ensuring accuracy and reliability.

In the step 3, heat flow balance constraints include energy flow topology constraints, energy conservation constraints, energy flow transfer and conversion constraints and component constraints. KCL (Kirchhoff's Current Law) equation is used to describe the energy conservation of the system, and KVL (Kirchhoff's Voltage Law) equation set reflects the heat transfer and conversion in heat flow method.

The constraint of working medium types is the analysis of working medium thermophysical properties. The working medium thermophysical properties are derived according to the basic thermodynamic state parameters. When the pressure is known during the phase change, the phase change temperature and latent heat may be directly obtained. The specific heat capacity is considered in three cases: the organic working medium in ORC system adopts the assumption of constant specific heat capacity; the specific heat capacity of LNG is sensitive to temperature change and is fitted by quadratic polynomial. Other working mediums adopt average specific heat capacity.

The system performance analysis in the step 4 includes energy analysis, exergy analysis and entransy transfer heat analysis. Energy analysis covers the solution of net power generation, system consumption ratio, system thermal efficiency and specific net power output, so as to ensure that the system power generation capacity is greater than the electricity consumption, meet the emission reduction targets, and reflect the utilization of LNG cold energy. The cold exergy efficiency of LNG is evaluated by the exergy analysis, which is used for the degree of cold energy recovery and the heat exchange efficiency of condenser. A new method is introduced for the entransy transfer heat analysis, which redefines the associated work, associated heat, associated heat dissipation and circulating net entransy transfer, and takes the ratio of the benefit and cost of entransy transfer as the evaluation index of the system performances.

In step 5, the optimal system configuration is determined by analyzing the influence of single decision variables (LNG pressure, seawater temperature and evaporation temperature) on the system performances. Furthermore, the synergistic effects of double-decision variables (LNG pressure and seawater temperature, LNG pressure and evaporation temperature) are analyzed, and the changes of system performance parameters are obtained. Using multi-objective optimization method, thermal efficiency and entransy transfer efficiency are selected as performance parameters, and genetic algorithm is used to optimize these two objectives to obtain Pareto frontier. TOPSIS (Technique for Order Preference by Similarity to an Ideal Solution) method is used to optimize the system performance parameters under different evaporator and seawater temperatures, and the optimal working point is determined.

### BRIEF DESCRIPTION OF THE DRAWINGS

FIG. 1 is a process of the method of the present disclosure.

FIG. 2A shows a general heat exchanger and the comparable thermal resistance topological graph.

FIG. 2B shows an evaporator and the comparable thermal resistance topological graph.

FIG. 2C shows a condenser and the comparable thermal resistance topological graph.

FIG. 2D shows a mixer and the comparable thermal resistance topological graph.

FIG. 2E shows a recondenser and the comparable thermal resistance topological graph.

FIG. 2F shows a throttle valve and the comparable thermal resistance topological graph.

FIG. 2G shows a pump and the comparable thermal resistance topological graph.

FIG. 2H shows a compressor and the comparable thermal resistance topological graph.

FIG. 2I shows a steam turbine and the comparable thermal resistance topological graph.

FIG. 2J shows a separator and the comparable thermal resistance topological graph.

FIG. 3 is a design diagram of a global heat flow topology optimization tool for cold energy recovery of floating storage regasification units.

FIG. 4 shows a process of cold energy recovery and regasification in a large and complex FSRU system.

FIG. 5A is a BOG system topology diagram of a large complex system with FSRU as an example.

FIG. 5B is an OC system topology diagram of a large complex system with FSRU as an example.

FIG. 5C is a Triple ORC system topology diagram of a large complex system with FSRU as an example.

### DETAILED DESCRIPTION OF THE EMBODIMENTS

### Embodiment

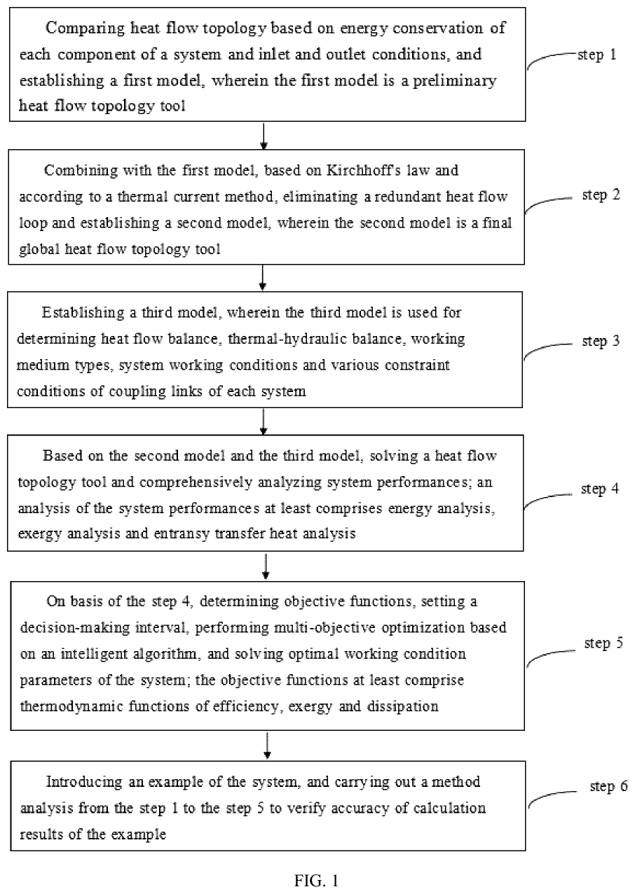

The disclosure relates to a global heat flow topology optimization tool for cold energy recovery of a floating storage regasification unit, which includes a summary diagram of global heat flow topology modeling and optimization of a complex system (as shown in FIG. 1), and specifically includes the following steps:
step 1, comparing heat flow topology based on energy conservation of each component of a system and inlet and outlet conditions, and establishing a preliminary heat flow topology tool;
step 2, combining with the preliminary heat flow topology tool, based on Kirchhoff's law and according to the thermal current method, eliminating the redundant heat flow loop and establishing the final global heat flow topology tool;
step 3, determining heat flow balance, thermal-hydraulic balance, working medium types, system working conditions and various constraint conditions of coupling links of each system;
step 4, based on the final global heat flow topology tool and heat flow balance, thermal-hydraulic balance, working medium types, system working conditions and various constraint conditions of coupling links of each system, solving the heat flow topology tool and comprehensively analyzing the system performance (energy analysis, exergy analysis and entransy transfer heat analysis, etc.);
step 5, on the basis of the step 4, determining objective functions (such as thermodynamic functions such as efficiency, exergy and dissipation), setting decision-making intervals, performing multi-objective optimization based on intelligent algorithm, and solving the optimal working condition parameters of the system; and
step 6, introducing an example of FSRU system, and analyzing the above methods to verify the accuracy of the calculation results of the example.

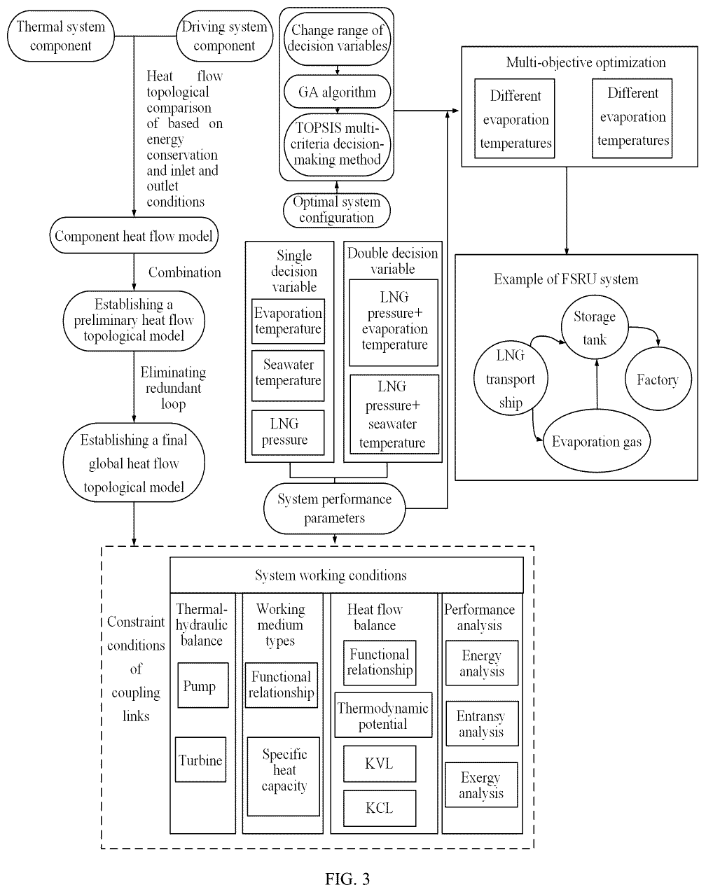

As shown in FIG. 3, the present disclosure provides the design flow of a global heat flow topology optimization tool for cold energy recovery of floating storage regasification units:
step 1, comparing heat flow topology based on energy conservation of each component of a system and inlet and outlet conditions, and establishing a preliminary heat flow topology tool;

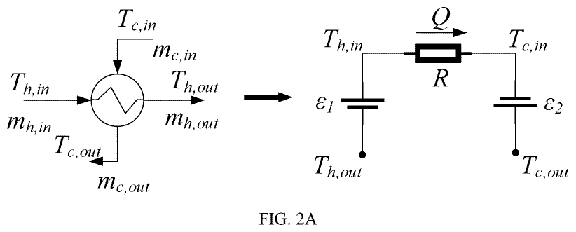

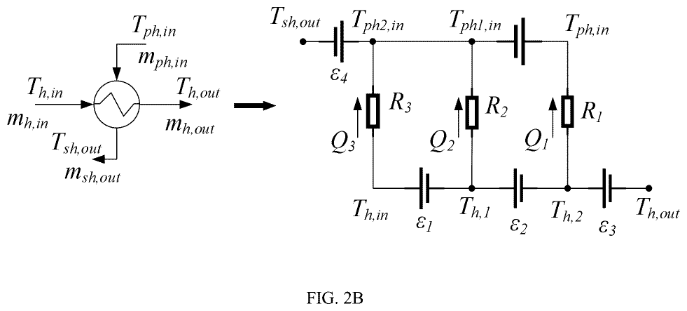

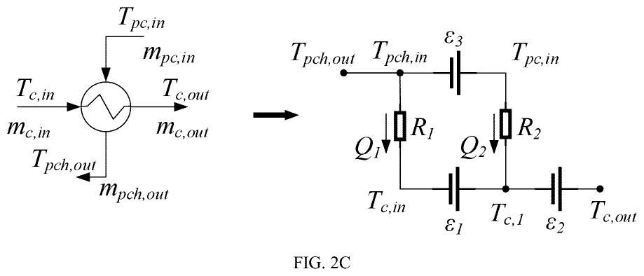

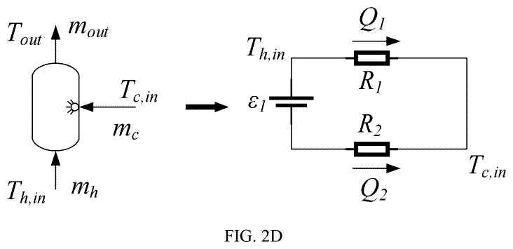

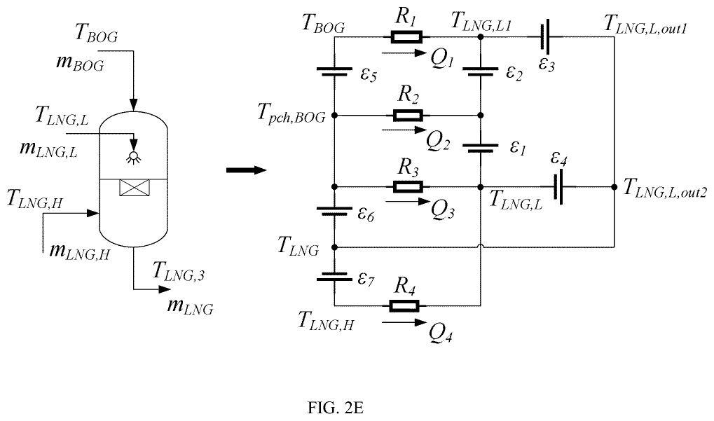

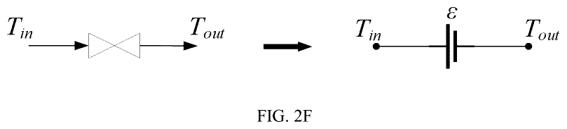

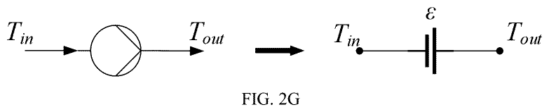

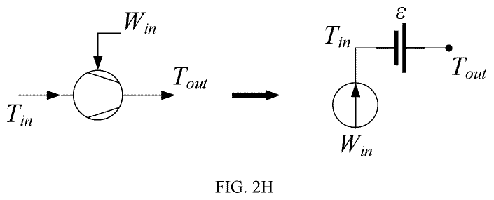

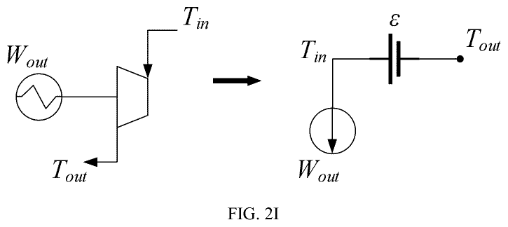

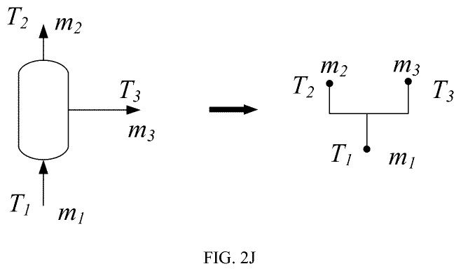

As shown in FIG. 2A-FIG. 2J, based on the comprehensive global heat flow topology tool of large-scale thermal system, the basic components in the thermal system are equivalent to the heat flow model including thermal resistance. For a heat exchanger with phase change process, the thermal resistance models are as follows:

$${R}_{pch , CON} = \frac{exp [ \frac{{( KA )}_{c}}{{G}_{c}} ]}{{G}_{c} exp [ \frac{{( KA )}_{c}}{{G}_{c}} ] - {G}_{c}} ;$$

$${R}_{pch , VAP} = \frac{exp [ \frac{{( KA )}_{c}}{{G}_{c}} ]}{{G}_{c} exp [ \frac{{( KA )}_{c}}{{G}_{c}} ] - {G}_{c}} ;$$

where (KA), is the heat transfer coefficient (W/m²K), G_{c} is the heat capacity rate of the working medium flowing through the device (W/K), subscript pch refers to the phase change stage, R_{pch,CON} is the thermal resistance (K/W) of phase change stage of the condenser, and R_{pch,CON} is the thermal resistance (K/W) of the phase change stage of the evaporator.

The basic components of the driving system are equivalent to a heat flow model including thermodynamic potential. Then, through the combination of each component model and the description of the system heat flow topology, the global heat flow topology tool is initially established.

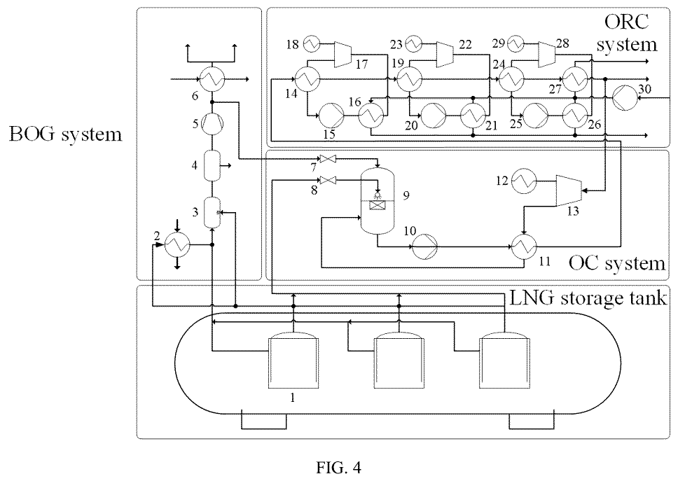

Step 2: describing the FSRU system: as shown in FIG. 4, the FSRU system in this example is based on ORC-OC technology and consists of three subsystems: BOG subsystem, three-level ORC subsystem and open-loop ORC (OC) subsystem. In the BOG subsystem, the flash steam generated by LNG indirectly contacts with LNG in the recondenser 9 through the heat exchanger, and is condensed into liquid LNG, pressurized and transported. The subsystem includes forced evaporator 2, mixer 3, separator 4, low-load compressor 5, gas cooler/heater 6 and other components. As an auxiliary power generation system, OC subsystem improves the power supply of FSRU, and includes a recondenser 9, a first driving pump 10, a first condenser 11, a first steam turbine 13, a heater 27, a first generator 12 and other components. LNG enters the recondenser after passing through the pressure reducing valve, and after exchanging heat with BOG, the cold energy is converted and utilized through various components, and finally the generator is driven to generate electricity. The three-level ORC subsystem uses the cold energy of LNG to meet the power demand of FSRU. The system includes several condensers, evaporators, driving pumps and steam turbines. The second condenser 14 is connected with the third condenser 19 and the fourth condenser 24, and transmits the organic working medium to the corresponding steam turbines through the driving pumps and evaporators respectively to drive the generators to generate electricity. The heater 27 introduces NG into the first steam turbine to further utilize external natural gas. The seawater pump 30 is responsible for providing cooling water for the evaporators and heaters, and discharging the cooling water after heat exchange.

Through the coordinated operation of these subsystems, the FSRU system may effectively utilize the cold energy of LNG and significantly improve the overall power supply capacity.

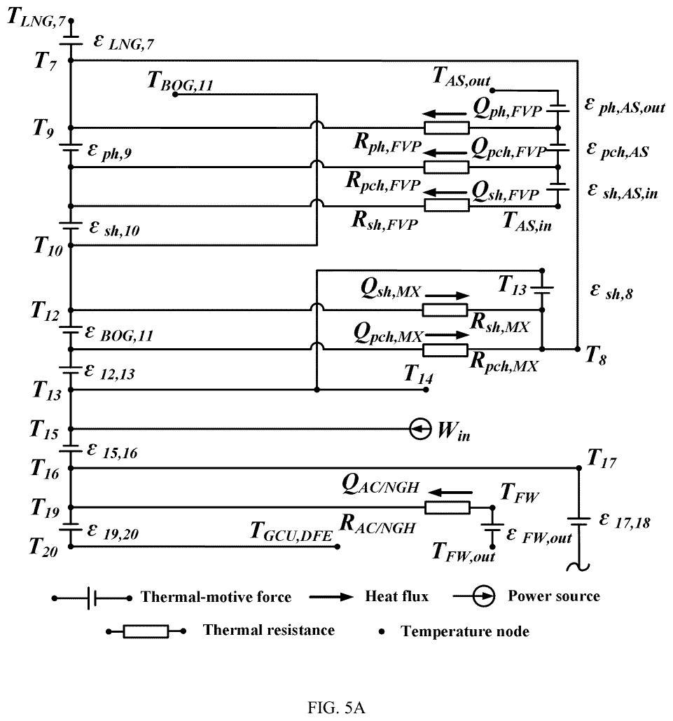

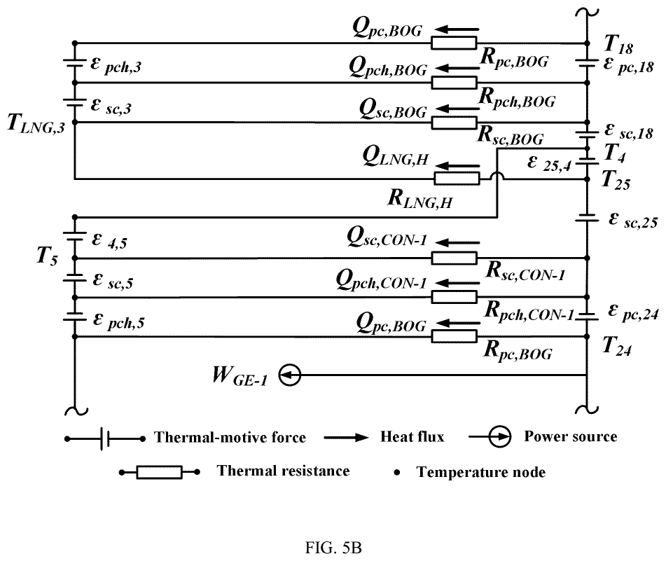

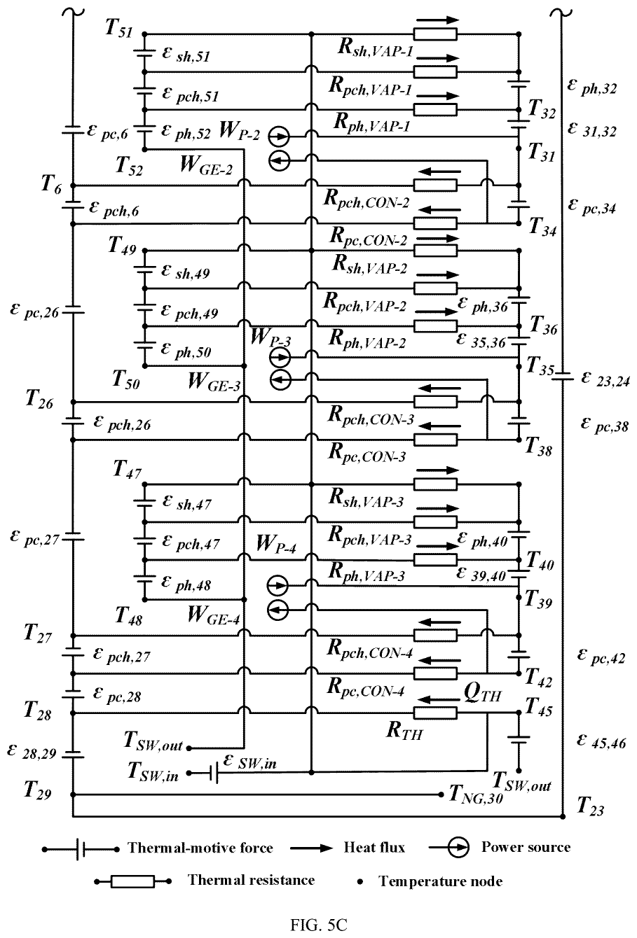

Step 3, eliminating the redundant heat flow loop and establishing the final global heat flow topology tool, as shown in FIG. 5A-FIG. 5C, that is, to establish the final global heat flow topology tool.

Step 4, determining the heat flow balance, thermal-hydraulic balance, working medium types, system working conditions and various constraint conditions of coupling links of each system.

The heat flow balance constraints include energy flow topology constraints, energy conservation constraints, energy flow transfer and conversion constraints and component constraints; among them, the KCL equation is used to obtain the energy conservation equation describing the thermal-power conversion process of the whole system:

$${W}_{GE - 4} + {W}_{GE - 3} + {W}_{GE - 2} + {W}_{GE - 1} + {Q}_{pch , MX} + {Q}_{sh , MX} + {Q}_{pc , BOG} + {Q}_{pch , BOG} + {Q}_{sh , BOG} + {Q}_{LNG , H} + {Q}_{pc , CON - 1} + {Q}_{pch , CON - 1} + {Q}_{pc , CON - 2} + {Q}_{pch , CON - 2} + {Q}_{pch , CON - 3} + {Q}_{pc , CON - 3} + {Q}_{pch , CON - 4} + {Q}_{pc , CON - 4} = {W}_{i n , LNG ,} + {W}_{i n , LDC} + {W}_{i n , FP} + {W}_{P - 1} + {W}_{P - 2} + {W}_{P - 3} + {W}_{P - 4} + {Q}_{sh , VAP - 1} + {Q}_{pch , VAP - 1} + {Q}_{sh , VAP - 2} + {Q}_{pch , VAP - 2} + {Q}_{p h , VAP - 2} + {Q}_{sh , VAP - 3} + {Q}_{pch , VAP - 3} + {Q}_{p h , VAP - 3} + {Q}_{TH} ;$$

in the formula, W_{GE-1}, W_{GE-2}, W_{GE-3} and W_{GE-4} represent external work by the first generator 12, second generator 18, third generator 23 and fourth generator 29 respectively (J); Q_{pch,MX} and Q_{sh,MX} are the heat transfer rates (W/MK) of the mixer in the phase change and overheating stages, respectively; Q_{pc, BOG}, Q_{sh, BOG}, and Q_{pch,BOG} are the heat transfer rates of volatile gas in pre-cooling, overheating and phase change stages respectively; Q_{LNG,H} is the heat transfer rate of high temperature LNG (W/MK); Q_{pc,CON-1}, Q_{pch,CON-1}, Q_{pc,CON-2}, Q_{pch,CON-2}, Q_{pc,CON-3}, Q_{pch,CON-3}, Q_{pc,CON-4} and Q_{pch,CON-4} are the heat transfer rates (W/MK) of the first condenser, second condenser, third condenser and fourth condenser in pre-cooling and phase change stages; W_{in, LNG} is the input work of LNG (J); W_{in,LDC} is input work of low-load compressor (J); W_{in,FP} is the input work of the feed pump (J); W_{P-1}, W_{P-2}, W_{P-3} and W_{P-4} respectively do work by the first driving pump, second driving pump, third driving pump and fourth driving pump (J); Q_{sh,VAP-1}, Q_{pch,VAP-1}, Q_{sh,VAP-2}, Q_{pch,VAP-2}, Q_{ph,VAP-2}, Q_{sh,VAP-3}, Q_{pch,VAP-3} and Q_{ph,VAP-3} are the heat transfer rates (W/MK) of the first evaporator, second evaporator, third evaporator and fourth evaporator in overheating, phase change and preheating stages respectively; Q_{TH} is the heat transfer rate (W/MK) of the heater 27.

KVL equation set reflects the heat transfer and conversion in the system by using the heat flow method:

$${T}_{LNG , 1} + {ε}_{LNG , 1} - {ε}_{V - 1} + {Q}_{sc , BOG} {R}_{sc , BOG} - {ε}_{sc , 8 , 9} + {ε}_{9 , 11} + {ε}_{sc , 10 , 11} + {ε}_{pch , 10 , 11} + {ε}_{pch , 11 , 14} + {ε}_{pc , 14 , 19} + {ε}_{pch , 14 , 19} + {ε}_{pc , 19 , 24} + {ε}_{pch , 19 , 24} + {ε}_{pc , 24 , 27} + {Q}_{TH} {R}_{TH} - {ε}_{SW , i n} = {T}_{SW , i n} ;$$

where T_{LNG,1} is the temperature (K) of LNG in the storage tank 1; ε_{LNG,1} is the thermodynamic potential (K) of LNG in the storage tank 1; ε_{V-1} is the thermodynamic potential (K) of the first pressure reducing valve 7; Q_{sc,BOG} is the heat transfer rate (W/MK) in the supercooling stage of volatile gas; R_{sc,BOG} is the thermal resistance (K/W) of the volatile gas in the supercooling stage; ε_{sc,8,9} are the thermodynamic potential (K) between the second pressure reducing valve 8 and the recondenser 9 in supercooling state; ε_{9,11} is the thermodynamic potential (K) between the recondenser 9 and the first condenser; ε_{sc,10,11} is the thermodynamic potential (K) between the first compressor and the first condenser in supercooling state; ε_{pch,10,11} is the thermodynamic potential (K) between the first compressor and the first condenser in the phase change state; ε_{pch,11,14} is the thermodynamic potential (K) between the first condenser and the second condenser in the phase change state; ε_{pc,14, 19} is the thermodynamic potential (K) between the second condenser and the third condenser in the pre-cooling state; ε_{pch,14,19} is the thermodynamic potential (K) in the phase change state between the second condenser and the third condenser; ε_{pc,19,24} is the thermodynamic potential (K) between the third condenser and the fourth condenser in the pre-cooling state; ε_{pch,19,24} is the thermodynamic potential (K) between the third condenser and the fourth condenser in the phase change state; ε_{pc,24,27} is the thermodynamic potential (K) between the third condenser and the fourth condenser in the pre-cooling state; Q_{TH} is the heat transfer rate of the heater (W/MK); R_{TH} is the thermal resistance of the heater (K/W); ε_{SW,in} is the thermodynamic potential (K) at the seawater inlet; T_{SW,in} is the temperature (K) of the input seawater.

Among them, the component constraints include heat exchanger constraints, and the heat exchanger constraints first include the above thermal resistance and thermodynamic potential constraint equations based on the thermal current method. In addition, the heat transfer performance parameters of single-phase heat exchanger are expressed by thermal conductivity (KA), and those of phase change heat exchanger are expressed by total heat transfer coefficient (K). That is, the change range of decision variables is given, the heat transfer performance parameters of the heat exchanger at different state points are simulated respectively, and finally the total heat transfer coefficient (K) or thermal conductivity coefficient (KA) under the off-design working condition is obtained by fitting the data with quadratic polynomial. The fitting equations are as follows:

$$K ( p ) = {K}_{0} [ {a ( \frac{p}{{p}_{0}} )}^{2} + b ( \frac{p}{{p}_{0}} ) + c ] ;$$

$$K ( {T}_{SW} ) = {K}_{0} [ {a ( \frac{{T}_{SW}}{{T}_{0}} )}^{2} + b ( \frac{{T}_{SW}}{{T}_{0}} ) + c ] ;$$

$$K ( {T}_{e} ) = {K}_{0} [ {a ( \frac{{T}_{e}}{{T}_{0}} )}^{2} + b ( \frac{{T}_{e}}{{T}_{0}} ) + c ] ;$$

p is pressure (Pa); K(p) represents the total heat transfer coefficient (W/m²K) when the pressure is a single decision variable; K₀ is the heat transfer coefficient in the initial state (W/m²K); T₀ is the temperature in the initial state; p₀ is the pressure in the initial state (PA); SW stands for seawater; T_{SW} is the seawater temperature; K(T_{SW}) represents the total heat transfer coefficient (W/m²K) when the seawater temperature is a single decision variable; e stands for evaporator; Tₑ is the evaporator temperature; K(Tₑ) represents the total heat transfer coefficient (W/m²K) when the evaporation temperature is a single decision variable; a, b and c are characteristic parameters respectively.

Among them, for heat exchangers in single-phase and phase-change states, the heat transfer area constraint equations are as follows:

$${A}_{VAP - i} = {A}_{p h {,}_{VAP - i}} + {A}_{pch {,}_{VAP - i}} + {A}_{s h {,}_{VAP - i}} , i = 1 , 2 , 3 ;$$

$${A}_{CON - i} = {A}_{p h {,}_{CON - i}} + {A}_{pch {,}_{CON - i}} + {A}_{s h {,}_{CON - i}} , i = 1 , 2 , 3 , 4 ;$$

Subscript ph is preheating stage, sh is overheating stage and pc is pre-cooling stage; A_{VAP-i} is the heat transfer area of the i-th evaporator (m²); A_{ph,VAP-i} is the heat transfer area (m²) of the i-th evaporator in preheating state; A_{pch,VAP-i} is the heat transfer area (m²) of the i-th evaporator in the phase change state; A_{sh,VAP-i} is the heat transfer area (m²) of the i-th evaporator in overheating state; A_{CON-i} is the heat transfer area (m²) of the i-th condenser; A_{ph,CON-i} is the heat transfer area (m²) of the i-th condenser in preheating state; A_{pch,CON-i} is the heat transfer area (m²) of the i-th condenser in the phase change state; A_{sh,CON-i} is the heat transfer area (m²) of the i-th condenser in the overheated state.

Among them, the energy-saving equations of the phase change process of the heat exchanger are as follows:

$${Q}_{p h , VAP - i} = {m}_{SW {,}_{VAP - i}} {γ}_{pch {,}_{V A P - i}} , i = 1 , 2 , 3 ;$$

$${Q}_{VAP - i} = {G}_{SW {,}_{VAP - i}} ( {T}_{SW , i n} - {T}_{SW , out} ) , i = 1 , 2 , 3 ;$$

$${Q}_{pch {,}_{CON - i}} = {m}_{NG {,}_{CON - i}} {γ}_{pch {,}_{CON - i}} , i = 1 , 2 , 3 , 4 ;$$

Q_{ph,VAP-i} is the heat transfer rate (W/MK) of the i-th evaporator in preheating state; Q_{VAP-i} is the heat transfer rate (W/MK) of the i-th evaporator; Q_{pch,VAP-i} is the heat transfer rate (W/MK) of the i-th evaporator in the phase change state; m_{SW,VAP-i} is the mass of seawater flowing through the i-th evaporator (kg); γ_{pch,VAP-i} is the latent heat of vaporization of the i-th evaporator in the phase change state; G_{SW,VAP-i} is the heat capacity ratio (W/K) of seawater flowing through the i-th evaporator; T_{SW,in} and T_{SW,out} are respectively the temperature (K) of the evaporator in and out of seawater; m_{NG,CON-i} is the flow rate (kg/s) of gaseous natural gas per unit mass flowing through the i-th condenser.

Among them, the component constraint also includes the turbine constraint, and the constraint equations describing the heat-work conversion process in the turbine are as follows:

$${η}_{T - 1} = \frac{{h}_{T - 1} ( {p}_{NG , T - 1 , i n} , {T}_{NG , T - 1 , i n} ) - {h}_{T - 1} ( {p}_{NG , T - 1 , out} , {T}_{NG , T - 1 , out} )}{{h}_{T - 1} ( {p}_{NG , T - 1 , i n} , {T}_{NG , T - 1 , i n} ) - {h}_{T - 1} ( {p}_{NG , T - 1 , out} , {T}_{NG , T - 1 , OUT , s} )} ;$$

$${η}_{T - 2} = \frac{{h}_{T - 2} ( {p}_{cf , T - 2 , i n} , {T}_{cf , T - 2 , i n} ) - {h}_{T - 2} ( {p}_{cf , T - 2 , out} , {T}_{cf , T - 2 , out} )}{{h}_{T - 2} ( {p}_{cf , T - 2 , i n} , {T}_{cf , T - 2 , i n} ) - {h}_{T - 2} ( {p}_{cf , T - 2 , out} , {T}_{cf , T - 2 , out , s} )} ;$$

$${η}_{T - 3} = \frac{{h}_{T - 3} ( {p}_{cf , T - 3 , i n} , {T}_{cf , T - 3 , i n} ) - {h}_{T - 3} ( {p}_{cf , T - 3 , out} , {T}_{cf , T - 3 , out} )}{{h}_{T - 3} ( {p}_{cf , T - 3 , i n} , {T}_{cf , T - 3 , i n} ) - {h}_{T - 3} ( {p}_{cf , T - 3 , out} , {T}_{cf , T - 3 , out , s} )} ;$$

$${η}_{T - 4} = \frac{{h}_{T - 4} ( {p}_{cf , T - 4 , i n} , {T}_{cf , T - 4 , i n} ) - {h}_{T - 4} ( {p}_{cf , T - 4 , out} , {T}_{cf , T - 4 , out} )}{{h}_{T - 4} ( {p}_{cf , T - 4 , i n} , {T}_{cf , T - 4 , i n} ) - {h}_{T - 4} ( {p}_{cf , T - 4 , out} , {T}_{cf , T - 4 , out , s} )} ;$$

where η_{T-1}, η_{T-2}, η_{T-3} and η_{T-4} are the efficiencies of the first steam turbine 13, second steam turbine 17, third steam turbine 22 and fourth steam turbine 28 respectively; HT-1, hT-2, hT-3 and hT-4 are the specific enthalpies (J/kg) of the first steam turbine, second steam turbine, third steam turbine and fourth steam turbine respectively; p_{NG,T-1,in} and p_{NG,T-1,out} and are the natural gas pressures (Pa) flowing into and out of the first steam turbine respectively; T_{NG,T-1,in} and T_{NG,T-1,out} are the temperatures (K) of natural gas flowing into and out of the first steam turbine respectively; T_{NG,T-1,out,s} is the temperature of natural gas flowing out of the first steam turbine under isentropic condition; p_{cf,T-2,in}, p_{cf,T-3,in} and p_{cf,T-4,in} are the pressures (Pa) of circulating fluid flowing into the second steam turbine, third steam turbine and fourth steam turbine respectively; p_{cf,T-2,out}, p_{cf,T-3,out} and p_{cf,T-4,out} are the pressures (Pa) of circulating fluid flowing out of the second steam turbine, third steam turbine and fourth steam turbine respectively; T_{cf,T-2,in}, T_{cf,T-3,in} and T_{cf,T-4,in} are the temperatures (K) of the circulating fluid flowing into the second steam turbine, third steam turbine and fourth steam turbine respectively; T_{cf,T-2,out}, T_{cf,T-3,out} and T_{cf,T-4,out} are the temperatures (K) of the circulating fluid flowing out of the second steam turbine, third steam turbine and fourth steam turbine respectively; T_{cf,T-2,out,s}, T_{cf,T-3,out,s} and T_{cf,T-4,out,s} are the temperatures (K) of the circulating fluids flowing out of the second steam turbine, third steam turbine and fourth steam turbine in isentropic state, respectively.

Among them, the component constraint also includes the compressor constraint. Due to the existence of the adiabatic efficiency of the compressor, the description of the heat-power conversion process of the compressor may be expressed by the following equation:

$${η}_{LDC , s} = \frac{{h}_{LDC} ( {p}_{BOG , out} , {T}_{BOG , out , s} ) - {h}_{LDC} ( {p}_{BOG , in} , {T}_{BOG , in} )}{{h}_{LDC} ( {p}_{BOG , out} , {T}_{BOG , out} ) - {h}_{LDC} ( {p}_{BOG , in} , {T}_{BOG , in} )} ;$$

where η_{LDC,s} is the efficiency of the compressor in adiabatic process; h_{LDC} is the specific enthalpy (J/kg) of the compressor; p_{BOG,in} and p_{BOG,out} are the pressure (PA) of volatile gas flowing into and out of the compressor respectively; T_{BOG,out,s} is the temperature (K) of volatile gas flowing out of the compressor under isentropic condition; T_{BOG,in} and T_{BOG,out} are the temperatures (K) of volatile gas flowing into and out of the compressor respectively.

Among them, component constraints also include pump group constraint, such as hot medium pump (seawater), cold medium pump (LNG), ORC working medium circulating pump and LNG feed pump.

Among them, the constraint on the working medium type may be derived from the basic thermodynamic state parameters according to the inherent functional relationship, and the constraint models are as follows:

$${T}_{pch , c} = f ( {p}_{pch} ) = {T}_{pch , CON - i} ( {p}_{pch , CON - i} ) ;$$

$${T}_{pch , e} = f ( {p}_{pch} ) = {T}_{pch , VAP - i} ( {p}_{pch , VAP - i} ) ;$$

$${γ}_{pch , c} = g ( {p}_{pch} ) = {h}_{sat , v} ( {p}_{pch , CON - i} ) - {h}_{sat , w} ( {p}_{pch , CON - i} ) ;$$

$${γ}_{pch , e} = g ( {p}_{pch} ) = {h}_{sat , v} ( {p}_{pch , VAP - i} ) - {h}_{sat , w} ( {p}_{pch , VAP - i} ) ;$$

where T_{pch,c} and T_{pch,e} are the phase change temperatures (K) of condenser and evaporator, respectively; γ_{pch,c} and γ_{pch,e} are the latent heat of phase change of condenser and evaporator respectively (J/kg); p_{pch} is the phase change process pressure (Pa); T_{pch,CON-i} and T_{pch,VAP-i} are the phase change temperatures (K) of the i-th condenser and evaporator, respectively; p_{pch,CON-i} and p_{pch,VAP-i} are the phase change process pressures (Pa) of the i-th condenser and evaporator respectively; h_{sat,v} and h_{sat,w} are the specific enthalpies (J/kg) before and after phase change, respectively.

When the pressure in the phase change process is known, the phase change temperature and phase change latent heat, as basic thermophysical parameters, may be directly obtained according to the above internal functional relationship.

Three different situations need to be considered in calculating the specific heat capacity of working mediums:
(1) For the organic working medium in ORC system, the assumption of constant specific heat capacity is usually adopted.
(2) For LNG, when the decision variable is temperature, the specific heat capacity of LNG is more sensitive to temperature change. Because of the need for quadratic polynomial fitting, the specific heat capacity of LNG in different decision variable intervals may be obtained. The model is as follows:

$${c}_{p} ( T ) = {aT}^{2} + bT + c ;$$

where a, b and c are characteristic parameters; cₚ is specific heat capacity (J/kg·k); Tis the temperature (K).
(3) For other working mediums, the average specific heat capacity is used to calculate the specific heat capacity under different working conditions:

$${c}_{p , eq} = \frac{h ( {p}_{in} , {T}_{in} ) - h ( {p}_{out} , {T}_{out} )}{{T}_{in} - {T}_{out}} ;$$

where c_{p,eq} is average specific heat capacity (J/kg·k); H h the specific enthalpy (J/kg); pᵢₙ and pₒᵤₜ are the air pressure (Pa) when the working medium flows in and out, respectively; Tᵢₙ and Tₒᵤₜ are the temperatures (K) when the working medium flows in and out, respectively.

Step 5, solving the heat flow topology tool and comprehensively analyzing the system performances (energy analysis, exergy analysis and entransy transfer heat analysis, etc.).

Among them, for energy analysis:
(1) Solving and analyzing the net power generation capacity of the system, and the models are as follows:

$${\dot{W}}_{demand} = \frac{( {\dot{W}}_{FP} + {\dot{W}}_{SW} + {\dot{W}}_{P - 1} + {\dot{W}}_{P - 2} + {\dot{W}}_{P - 3} + {\dot{W}}_{P - 4} )}{{η}_{P , s}} + \frac{{\dot{W}}_{LDC}}{{η}_{LDC , s}} ;$$

$${\dot{W}}_{require} = \frac{( {\dot{W}}_{T - 1} + {\dot{W}}_{T - 2} {\dot{+ W}}_{T - 3} + {\dot{W}}_{T - 4} )}{{η}_{T}} ;$$

$${\dot{W}}_{net} = {\dot{W}}_{require} - {\dot{W}}_{demand} ;$$

where \dot{W}_{demand} is the power demand of the system (J); \dot{W}_{require} is the system power generation capacity (J); \dot{W}_{FP} is the energy consumed by the feed pump (J); \dot{W}_{SW} is the energy consumed by seawater pump (J); \dot{W}_{P-1}, \dot{W}_{P-2}, \dot{W}_{P-3} and \dot{W}_{P-4} are the energy (J) consumed by the first driving pump 10, second driving pump 15, third driving pump 20 and fourth driving pump 25 respectively; \dot{W}_{T-1}, \dot{W}_{T-2}, \dot{W}_{T-3} and \dot{W}_{T-4} are the energy generated by the first steam turbine 13, second steam turbine 17, third steam turbine 22 and fourth steam turbine 28 respectively (J); η_{P,s} is the pump efficiency under isentropic condition; \dot{W}_{LDC} is the energy consumed by the compressor (J); η_{LDC,s} is the compressor efficiency under isentropic condition; η_{T} is the turbine efficiency; \dot{W}ₙₑₜ is the net power generation capacity (J) of the system.

The power generated by FSRU is greater than the required power.
(2) The consumption ratio (Supply/demand ratio) may reflect whether the FSRU system meets the carbon emission reduction standards, and may get the proportional relationship between power generation capacity and demand power. The model is as follows:

$$S D R = \frac{{\dot{W}}_{require}}{{\dot{W}}_{demand}} .$$

(3) The thermal efficiency ηₑ performance evaluation parameter measures the energy utilization efficiency in the process of thermal energy conversion, and the model is as follows:

$${η}_{e} = \frac{{\dot{W}}_{net}}{{\dot{Q}}_{in}} ;$$

where \dot{Q}ᵢₙ is the input heat (J) of the system.
(4) The performance evaluation index of specific net power output (SNPO) may reflect the cold energy utilization of LNG under different working conditions, and the model is as follows:

$$S N P O = \frac{{\dot{W}}_{net}}{{\dot{m}}_{LNG}} ;$$

where \dot{m}_{LNG} is the flow rate of LNG per unit mass (kg/s).

Among them, for exergy analysis, exergy is often used to describe the availability of energy, and the exergy of the power generation system includes chemical dissipation and physical dissipation.

$${\dot{E}}_{x} = \dot{m} {e}^{ph} ;$$

$${e}^{ph} = ( h - {h}_{0} ) - {T}_{0} ( s - {s}_{0} ) ;$$

where Ėₓ is exergy (KW); \dot{m} is the fluid flow per unit mass (kg/s); e^{ph} is the ratio exergy of preheating process (kj/mol); h is the specific enthalpy (J/kg); h₀ is the specific enthalpy input value of working medium (J/kg); T₀ is the initial temperature value (K) of the working medium; s is entropy (J/K); s₀ is the initial value of entropy (J/K).

LNG cold exergy efficiency (η_{ce}) may be used to evaluate the degree of cold energy recovery of the system, and may also reflect the heat exchange efficiency of the condenser. Its model is as follows:

$${η}_{ce} = \frac{{\dot{E}}_{x , benefit}}{{\dot{E}}_{x , cos t}} ;$$

where Ė_{x,benefit} is useful exergy (KW); Ė_{x,cost} is the consumption exergy (kW).

Among them, for the entransy transfer heat analysis: in the background of FSRU system in this example, the entransy dissipation transfer related to associated heat in this system may be described by the following equations:

$${\dot{ϕ}}_{{E}_{n , f , e}} = {\dot{E}}_{n , f , Q , SW} - {\dot{E}}_{n , f , Q , cf} ;$$

$${\dot{ϕ}}_{{E}_{n , f , c}} = {\dot{E}}_{n , f , Q , cf} - {\dot{E}}_{n , f , Q , LNG} ;$$

where

$${\dot{ϕ}}_{{E}_{n , f , e}} and {\dot{ϕ}}_{{E}_{n , f , c}}$$

are the entransy transfer dissipation rate (W·K) of evaporator and condenser respectively; Ė_{n,f,Q,SW}, Ė_{n,f,Q,cf} and Ė_{n,f,Q,LNG} are the entransy transfer associated heat (W·K) of seawater, circulating liquid and LNG, respectively.

The entransy transfer related to net work may be calculated by the entransy transfer related to associated heat, and the equation is as follows:

$${\dot{E}}_{n , f , benefit} = ( {\dot{E}}_{n , f , Q , H} - {\dot{ϕ}}_{{E}_{n , f , H}} ) - ( {\dot{E}}_{n , f , Q , C} - {\dot{ϕ}}_{{E}_{n , f , C}} ) ;$$

where Ė_{n,f,benefit} is useful entransy transfer (W·K); Ė_{n,f,Q,H} and Ė_{n,f,Q,C} are entransy transfer associated heat (W·K) in hot and cold states, respectively.

$${\dot{ϕ}}_{{E}_{n , f , H}} and {\dot{ϕ}}_{{E}_{n , f , C}}$$

are respectively the entransy transfer dissipation rate (W·K) in hot and cold states.

The above calculation leads to the system performance evaluation index (GB). It is defined as the ratio of entransy transfer income to entransy transfer cost:

$${η}_{et} = \frac{\sum \vert {\dot{E}}_{n , f , benefit} \vert}{\sum \vert {\dot{E}}_{n , f , cost} \vert} = \frac{\vert ( {\dot{E}}_{n , f , Q , H} - {\dot{ϕ}}_{{E}_{n , f , H}} ) - ( {\dot{E}}_{n , f , Q , C} - {\dot{ϕ}}_{{E}_{n , f , C}} ) \vert}{{\dot{E}}_{n , f , Q , H}} ;$$

Step 6, determining the objective functions (such as thermodynamic functions such as efficiency, exergy and dissipation), setting the decision-making interval, performing multi-objective optimization based on intelligent algorithm, and solving the optimal working condition parameters of the system. Among them, in this example, FSRU uses pure organic materials in the three-level ORC. The temperature range of LNG regasification process is −162° C.−10° C., and the boiling point of organic working medium should match the temperature change range of LNG regasification process.

Among them, the mathematical model of FSRU system is solved by a hierarchical and classified algorithm, and the process of system simulation follows the following algorithm flow.
(1) First, inputting the boundary and operating conditions for simulation.
(2) Setting initial values for subsequent iterations, including heat exchanger areas: A_{CON-1,pch}, A_{CON-2,pch}, A_{CON-3,pch}, A_{CON-4,pch}, A_{VAP-1,pch}, A_{VAP-2,pch}, A_{VAP-3,pch}, A_{HEX1}, A_{MX}; working medium mass flow: \dot{m}_{SW,45}, \dot{m}_{SW,47}, \dot{m}_{SW,49}, \dot{m}_{SW,51}, \dot{m}_{NG,23}, \dot{m}_{cf,1}, \dot{m}_{cf,2}, \dot{m}_{cf,3}; power generated by corresponding components: \dot{W}_{LDC}, \dot{W}_{P-2}, \dot{W}_{P-3}, \dot{W}_{P-4}, \dot{W}_{T-1}, \dot{W}_{T-2}, \dot{W}_{T-3}, \dot{W}_{T-4}.
(3) Calculating the heat transfer performance parameters related to the heat exchanger, such as the total heat transfer coefficient and thermal conductivity.
(4) Calculating the related thermal resistance and thermodynamic potential based on the heat flow method.
(5) Solving KCL and KVL equations by matrix elimination method.
(6) Obtaining the temperature and pressure at the important nodes of the whole system.
(7) Updating the assumed values of the power generated by the corresponding components until converging.
(8) Updating the assumed values of the corresponding working medium mass flow until converging.
(9) Calculating the relevant performance evaluation parameters after all the above assumptions converge.

By comparison, all the errors are within 5.6%. This result effectively verifies the reliability of the proposed global heat flow topology tool.

Step 7, end.

What is claimed is:

1. A global heat flow topology optimization tool for cold energy recovery of floating storage regasification units, comprising following steps:
step 1, comparing heat flow topology based on energy conservation of each component of a system and inlet and outlet conditions, and establishing a first model, wherein the first model is a preliminary heat flow topology tool;
step 2, combining with the first model, based on Kirchhoff's law and according to a thermal current method, eliminating a redundant heat flow loop and establishing a second model, wherein the second model is a final global heat flow topology tool;
step 3, establishing a third model, wherein the third model is used for determining heat flow balance, thermal-hydraulic balance, working medium types, system working conditions and various constraint conditions of coupling links of each system;
step 4, based on the second model and the third model, solving a heat flow topology tool and comprehensively analyzing system performances, wherein an analysis of the system performances at least comprises energy analysis, exergy analysis and entransy transfer heat analysis;
step 5, on basis of the step 4, determining objective functions, setting a decision-making interval, performing multi-objective optimization based on an intelligent algorithm, and solving optimal working condition parameters of the system, wherein the objective functions at least comprise thermodynamic functions of efficiency, exergy and dissipation; and
step 6, introducing an example of the system, and carrying out a method analysis from the step 1 to the step 5 to verify accuracy of calculation results of the example.

2. According to claim 1, in the step 1, a modeling of the preliminary heat flow topology tool comprises: all heat conversion devices are equivalent to heat flow models comprising thermal resistance; all driving devices are equivalent to heat flow models comprising thermodynamic potential.

3. According to claim 1, in the step 2, a method for establishing the final global heat flow topology tool is as follows: when constructing the heat flow models, based on the Kirchhoff's law and according to the thermal current method, only a closed loop comprising thermodynamic potential represents temperature change in the closed loop, the thermodynamic potential is eliminated without changing the basic properties of the system, and the final global heat flow topology tool is established.

4. According to claim 1, in the step 3, heat flow balance constraints comprise energy flow topology constraints, energy conservation constraints, energy flow transfer and conversion constraints and component constraints; wherein a KCL (Kirchhoff's Current Law) equation is used to obtain an energy conservation equation describing a thermal-power conversion process of a whole system; heat transfer and conversion in the system are reflected by a use of a heat flow method by a KVL (Kirchhoff's Voltage Law) equation set.

5. According to the step 4 of claim 1, the energy analysis comprises solving and analyzing net power generation capacity, system consumption ratio, system thermal efficiency and specific net power output to ensure power generation capacity to meet an emission reduction target; LNG (liquefied natural gas) cold exergy efficiency and condenser heat exchange efficiency are evaluated by the exergy analysis; during the entransy transfer heat analysis, by redefining associated work and associated heat, a ratio of benefit to cost of entransy transfer is obtained as an evaluation index of the system performances.

6. According to the step 5 of claim 1, a most efficient system configuration is obtained by analyzing influence of single decision variables such as LNG pressure, seawater temperature and evaporation temperature on the system performances; then, a synergistic effect of double-decision variables such as the LNG pressure, the seawater temperature or the evaporation temperature to optimize the system performances.

7. According to the step 5 of claim 1, two key parameters, thermal efficiency and entransy transfer efficiency, are selected by a multi-objective optimization method, and Pareto frontier is obtained by balancing the two key parameters by a genetic algorithm; then the evaporator temperature and seawater temperature are optimized by TOPSIS (Technique for Order Preference by Similarity to an Ideal Solution) method to determine an optimal working point of the system.

8. According to the step 6 of claim 1, the models are identified by using examples, an optimal configuration of organic working medium is determined through single decision variable analysis, and the multi-objective optimization and the genetic algorithm are used to balance the thermal efficiency and the entransy transfer efficiency, and finally an optimal working point is obtained through TOPSIS method; errors are all within 5.6%, proving accuracy of the models.
